(19) United States
(12) Patent Application Publication
(10) Pub. No.: US 2016/0269117 A1
(43) Pub. Date: Sep. 15, 2016

(54) OPTICAL COMMUNICATION DEVICE

(71) Applicant: TRANSYSTEM INC., Hsinchu City (TW)

(72) Inventor: Lee-Chuan CHANG, Zhudong Township (TW)

(21) Appl. No.: 14/753,541

(22) Filed: Jun. 29, 2015

(30) Foreign Application Priority Data
Mar. 13, 2015 (TW) 104203772

(51) Int. Cl. H04B 10/40; H04J 14/02

(52) U.S. Cl. CPC H04B 10/40; H04J 14/0221

(57) ABSTRACT

An optical communication device includes: a heat-dissipation base; an insulating housing disposed on the heat-dissipation base, made of a heat-insulating material, and defining an inner space that has an opening facing the heat-dissipation base; a circuit board disposed in the inner space; an optical transceiver disposed in the inner space and on the circuit board; and a thermoelectric cooler disposed on the heat-dissipation base, and electrically connected to an external temperature control circuit, received in the opening, controlled by an external temperature control circuit, and being configured for heating and cooling the optical transceiver so as to control temperature of the optical transceiver.

### CROSS-REFERENCE TO RELATED APPLICATION

This application claims priority of Taiwanese Application No. 104203772, filed on Mar. 13, 2015, the entire disclosure of which is hereby incorporated by reference.

### FIELD

This disclosure relates to an optical communication device, and more particularly to an optical communication device that includes an insulating housing made of a heat-insulating material.

### BACKGROUND

Communication network topologies (such as star topology, bus topology and daisy chain topology) involve communications among a plurality of optical transmitters and an optical receiver. In general, each of the optical transmitters has a different wavelength of light by using coarse wavelength division multiplexing (abbreviated as CWDM) or dense wavelength division multiplexing (abbreviated as DWDM). However, using CWDM and DWDM leads to a higher storage cost and a higher manufacturing cost. A conventional optical communication device such as CWDM and DWDM DFB Laser Module includes an optical transceiver and a temperature controller that is configured for controlling the temperature of the optical transceiver. However, the laser diode and the temperature controller are both attached to a package that encloses the controller therein and that is usually made of a high thermally conductive metal-ceramic material. As a result, heat generated by the laser diode being transferred to the package may adversely affect temperature control of the temperature controller.

### SUMMARY

Therefore, an object of the disclosure is to provide an optical communication device that can transform a low cost conventional laser diode or transceiver into a CWDM laser diode or transceiver via temperature control mechanism, such a mechanism provides very effective control of the temperature and alleviate at least one of the drawbacks of the prior arts.

According to the disclosure, the optical communication device includes a heat-dissipation base, an insulating housing, a circuit board, an optical transceiver and a temperature controller. The insulating housing is disposed on the heat-dissipation base, is made of a heat insulating material, and defines an inner space that has an opening facing the heat-dissipation base. The circuit board is disposed in the inner space. The optical transceiver is disposed in the inner space and on the circuit board. The one side of the thermalelectric cooler (TEC) is physically disposed on the heat-dissipation base, and electrically controlled by an external control circuit. And the other side of the thermalelectric cooler is received in the opening, is physically disposed on the thermal conductive unit, and then it is configured for heating and cooling the thermal conductive unit so as to control temperature of the optical transceiver.

### BRIEF DESCRIPTION OF THE DRAWINGS

Other features and advantages of the disclosure will become apparent in the following detailed description of the embodiment with reference to the accompanying drawings, of which:

FIG. 1 is an assembled perspective view illustrating the embodiment of an optical communication device according to the disclosure;

FIG. 2 is an exploded top perspective view illustrating the embodiment of the optical communication device;

FIG. 3 is an exploded bottom perspective view illustrating the embodiment of the optical communication device; and

FIG. 4 is a fragmentary sectional view illustrating the embodiment of the optical communication device.

### DETAILED DESCRIPTION

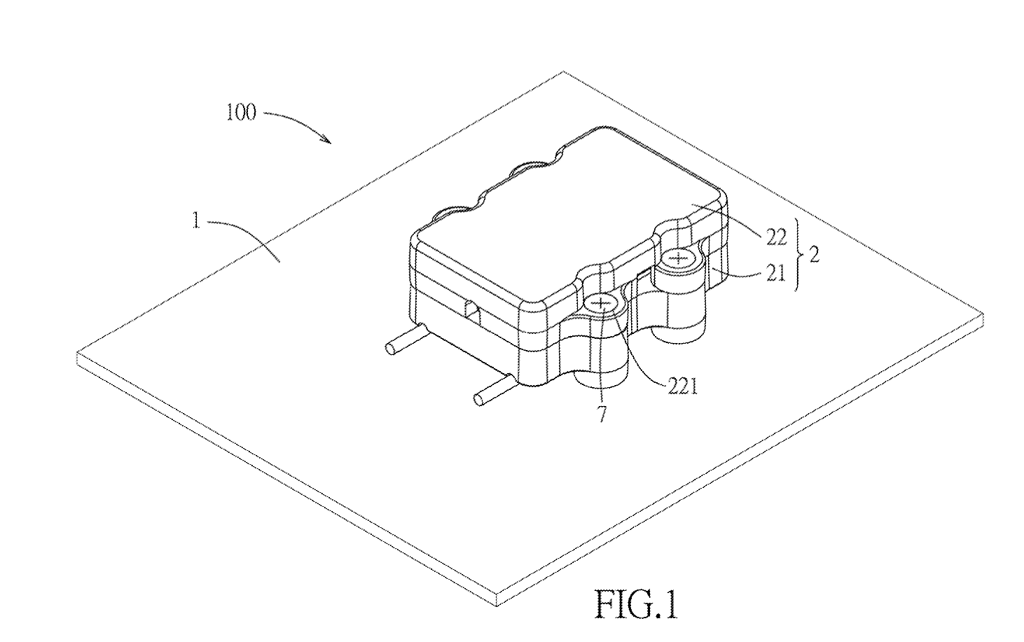

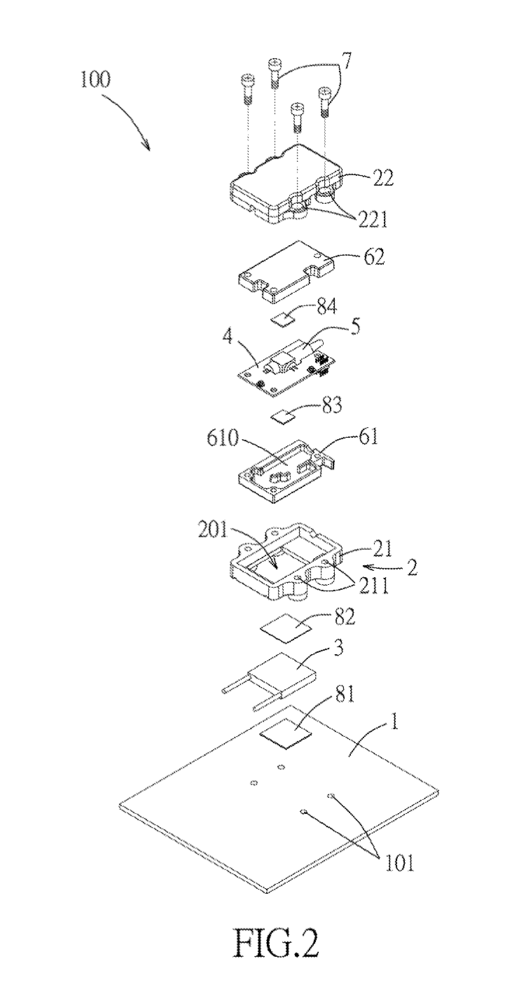

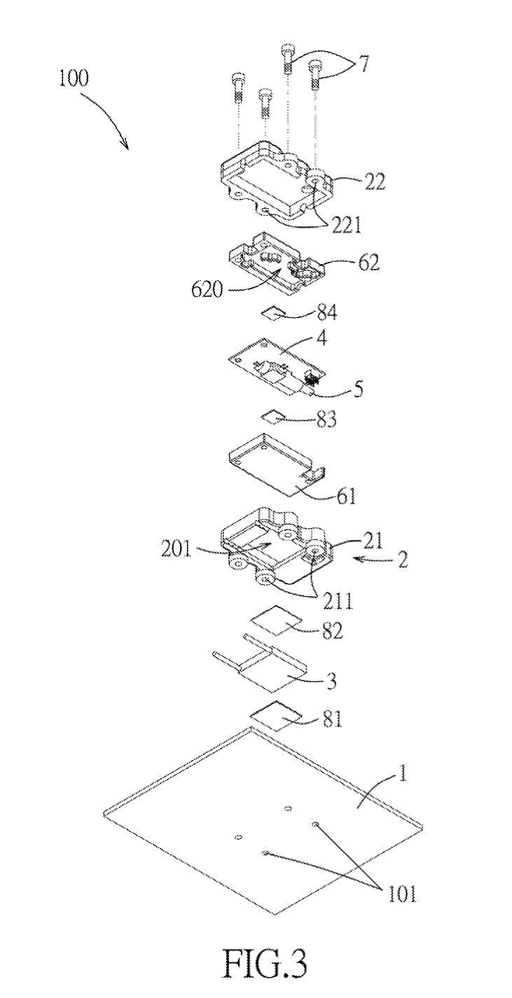

Referring to FIGS. 1 to 4, the embodiment of an optical communication device 100 according to this disclosure includes a heat-dissipation base 1, an insulating housing 2, a circuit board 4, an optical transceiver 5, a thermalelectric cooler 3, a thermal conductive unit 6, a plurality of positioning members 7 and a plurality of thermal conductive pads or paste 8.

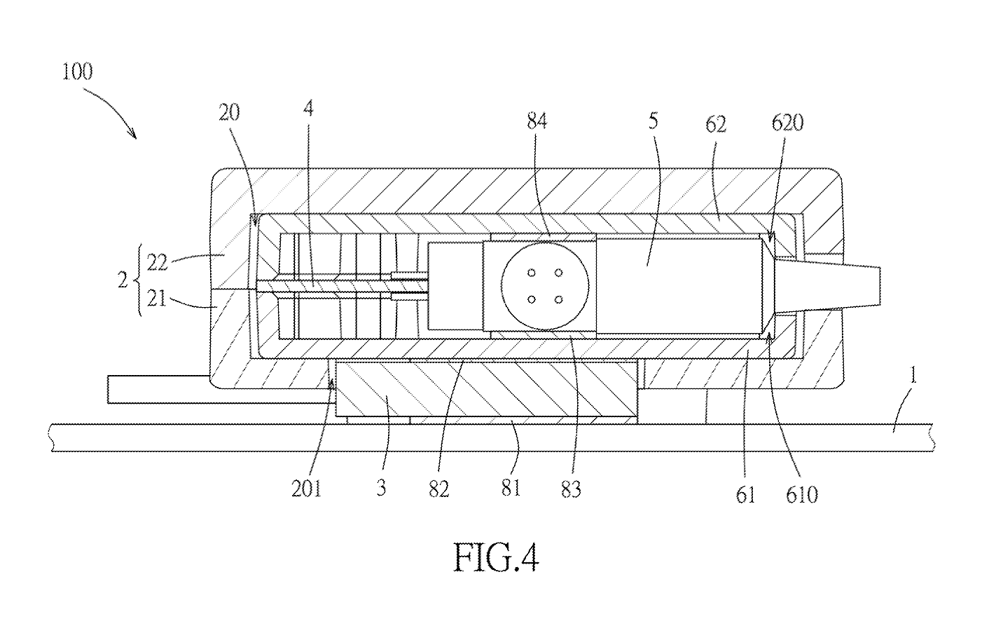

The insulating housing 2 is disposed on the heat-dissipation base 1, defines an inner space 20 (see FIG. 4) that has an opening 201 facing the heat-dissipation base 1, and is made of a heat-insulating material so that the temperature inside the inner space 20 is not easily affected by the ambient temperature of the environment outside of the insulating housing 2. In this embodiment, the insulating housing 2 is made of, for example but not limited to, a plastic material. The insulating housing 2 includes a first housing portion 21 and a second housing portion 22. The first housing portion 21 is disposed between the second housing portion 22 and the heat-dissipation base 1. The first housing portion 21 is formed with a plurality of first positioning holes 211. The second housing portion 22 is formed with a plurality of second positioning holes 221 that are respectively corresponding in position to the first positioning holes 211.

The heat-dissipation base 1 is formed with a plurality of third positioning holes 101 that are respectively corresponding in position to the first positioning holes 211.

Each of the positioning members 7 extends through a respective one of the first positioning holes 211, a respective one of the second positioning holes 221 and a respective one of the third positioning holes 101 to fasten the insulating housing 2 to the heat dissipation base 1. In this embodiment, each of the positioning member 7 is, for example but not limited to, a screw.

The circuit board 4 is disposed in the inner space 20 and is electrically connected to an external electric circuit (not shown) via a wire (not shown).

The optical transceiver 5 is disposed in the inner space 20 and on the circuit board 4, and is electrically connected to the circuit board 4. In this embodiment, the optical transceiver 5 is a single-fiber bidirectional (abbreviated as BiDi) optical transceiver which is connected to an optical fiber (not shown) so as to transport and receive optical signals via the optical fiber.

The thermoelectric cooler 3 is disposed on and electrically connected to an external temperature controller (not shown), is received in the opening 201, and is configured for heating and cooling the thermal conductive unit 6, so as to control the temperature of the optical transceiver 5.

The thermal conductive unit 6 includes a first thermal conductive block 61 and a second thermal conductive block 62. The first thermal conductive block 61 is disposed in the inner space 20 and between the thermoelectric cooler 3 and the optical transceiver 5, defines a first receiving space 610 that receives a portion of the optical transceiver 5, and is made of a material having a high thermal conductivity. The second thermal conductive block 62 is disposed in the inner space 20 and on a side of the first thermal conductive block 61 that is distal from thermoelectric cooler 3, defines a second receiving space 620 that receives another portion of the optical transceiver 5, and is made of a material having a high thermal conductivity. To be more specific, the first thermal conductive block 61 and the second thermal conductive block 62 are respectively disposed at two opposite sides of the optical transceiver 5 and the circuit board 4. In this embodiment, the thermal conductive unit 6 is made of, for example but not limited to, a metallic material.

In this embodiment, the number of the thermal conductive pads 8 is four. In order to distinguish the thermal conductive pads 8 from each other, they are divided into first to fourth thermal conductive pads 81, 82, 83, 84. The first thermal conductive pad 81 is disposed between the heat-dissipation base 1 and the temperature controller 3. The second thermal conductive pad 82 is disposed between the temperature controller 3 and the first thermal conductive block 61. The third thermal conductive pad 83 is disposed between first thermal conductive block 61 and the optical transceiver 5. The fourth thermal conductive pad 84 is disposed between the second thermal conductive block 62 and the optical transceiver 5. It should be noted that the thermal conductive pads 8 are made of materials each having a high thermal conductivity, and are disposed in the clearances inside the optical communication device 100 for reducing the thermal resistance among components of the optical communication device 100. In some examples, when the clearances among the components of the optical communication device 100 are reduced, the thermal conductive pads 8 may be omitted depending actual requirements. In some examples, the thermal conductive pads 8 may be replaced by materials having similar heat-dissipation effect, such as thermal grease (also known as thermal compound and thermal paste).

In this embodiment, the circuit board 4 includes a temperature sensor (not shown) to detect temperature nearby and to send signals back to an external temperature controller (not shown). During operation, according to the signals sent from the temperature sensor, the heat-dissipation base 1 controls the temperature controller 3 to heat or cool the optical transceiver 5 to a pre-determined temperature. The wavelength of the optical signal from the transceiver 5 is controlled by the temperature of the optical transceiver 5. In general, the wavelength of the optical signal from the transceiver 5 changes about 0.1 nm when the temperature of the optical transceiver 5 changes about 1 degree C. Therefore, by controlling the temperature of the optical transceiver 5, the wavelength of the optical signal can be controlled within a pre-determined range.

The optical communication device according to this disclosure has the following advantages:

(1) Since the insulating housing 2 is made of the heat-insulating material, the temperature inside the inner space 20 of the insulating housing 2 is not easily affected by the ambient temperature of the environment outside of the insulating housing 2. Therefore, the temperature of the optical transceiver 5 disposed in the inner space 20 is mainly affected by the thermoelectric cooler 3.

(2) Since the thermal conductive unit 6 and the thermal conductive pads 8 are made of materials having high thermal conductivities, they facilitate the heating and cooling processes of the thermoelectric cooler 3 to the optical transceiver 5, so that the thermal energy can be rapidly transferred into and out of the optical transceiver 5 and the inner space 20 (which includes the first receiving space 610 and the second receiving space 620).

(3) The structure of the optical communication device 100 is easy to manufacture, thereby lowering the manufacturing cost.

To sum up, due to the presence of the insulating housing 2, the thermal conductive unit 6 and the thermal conductive pads 8, the temperature of the optical transceiver 5 can be effectively controlled to the pre-determined temperatures. When using a plurality of the optical communication devices 100 to constitute a communication system, each optical transceiver 5 in each of the optical communication devices 100 can be controlled to generate different wavelengths of the optical signal to achieve an effect similar to that of coarse wavelength division multiplexer (abbreviated as CWDM). Since each optical transceiver 5 has the same specification, and general available from market, so the storage cost and the manufacturing cost can be reduced. As a result, the object of the disclosure can be achieved.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed:

1. An optical communication device, comprising:
a heat-dissipation base;
an insulating housing disposed on said heat-dissipation base, made of a heat-insulating material, and defining an inner space that has an opening facing said heat-dissipation base;
a circuit board disposed in said inner space;
an optical transceiver disposed in said inner space and on said circuit board; and
a thermoelectric cooler disposed on the said heat-dissipation base, and connected to an temperature control circuit, and received in said opening, controlled by said temperature control circuit, and being configured for heating and cooling said optical transceiver so as to control temperature of said optical transceiver.

2. The optical communication device as claimed in claim 1, further comprising a thermal conductive unit that includes a first thermal conductive block disposed in said inner space and between said temperature controller and said optical transceiver, defining a first receiving space that receive a portion of said optical transceiver, and made of a material having a high thermal conductivity.

3. The optical communication device as claimed in claim 2, wherein said thermal conductive unit further includes a second thermal conductive block disposed in said inner space and on a side of said first thermal conductive block that is distal from said temperature controller, defining a second receiving space that receives another portion of said optical transceiver, and made of the material having the high thermal conductivity.

4. The optical communication device as claimed in claim 1, wherein:
said insulating housing includes a first housing portion and a second housing portion, said first housing portion being disposed between said second housing portion and said heat-dissipation base, said first housing portion being formed with a plurality of first positioning holes, said second housing portion being formed with a plurality of second positioning holes that are respectively corresponding in position to said first positioning holes;
said optical communication device further comprises a plurality of positioning members each extending through a respective one of said first positioning holes and a respective one of said second positioning holes to fasten said insulating housing to said heat dissipation substrate.

5. The optical communication device as claimed in claim 4, wherein each of said positioning members is a screw.

6. The optical communication device as claimed in claim 3, further comprising a plurality of thermal conductive pads, one of said thermal conductive pads being disposed between said heat-dissipation base and said temperature controller, another one of said thermal conductive pads being disposed between said temperature controller and said first thermal conductive block.

7. The optical communication device as claimed in claim 3, further comprising a plurality of thermal conductive pads, one of said thermal conductive pads being disposed between first thermal conductive block and said optical transceiver, another one of said thermal conductive pads being disposed between the second thermal conductive block and said optical transceiver.

8. The optical communication device as claimed in claim 1, wherein said optical transceiver is a single-fiber bidirectional optical transceiver.

9. The optical communication device as claimed in claim 1, wherein said insulating housing is made of a plastic material.

10. The optical communication device as claimed in claim 3, wherein said thermal conductive unit is made of a metallic material.
